(19) United States
(12) Patent Application Publication
(10) Pub. No.: US 2014/0080104 A1
(43) Pub. Date: Mar. 20, 2014

(54) KANJI STROKE ORDER LEARNING DEVICE, KANJI STROKE ORDER LEARNING SUPPORT METHOD, KANJI STROKE ORDER LEARNING SYSTEM AND RECORDING MEDIUM IN WHICH KANJI STROKE ORDER LEARNING PROGRAM IS RECORDED

(71) Applicant: CASIO COMPUTER CO., LTD., Tokyo (JP)

(72) Inventor: Yuki SATO, Tokyo (JP)

(73) Assignee: CASIO COMPUTER CO., LTD., Tokyo (JP)

(21) Appl. No.: 14/026,841

(22) Filed: Sep. 13, 2013

(30) Foreign Application Priority Data
Sep. 14, 2012 (JP) 2012-202368

(51) Int. Cl. G09B 11/00

(52) U.S. Cl. CPC G09B 11/00
USPC 434/162

(57) ABSTRACT

Disclosed is a kanji stroke order learning device including a kanji part stroke order storage unit which stores a plurality of stroke order data of kanji parts, a kanji part combination storage unit which stores kanji and kanji parts included in the kanji in association to each other, a kanji specifying unit which specifies any kanji as a specified kanji, a stroke order input unit which inputs stroke order of the specified kanji, a kanji part stroke order determination unit which determines whether the stroke order of the specified kanji input by the stroke order input unit is correct or incorrect for each kanji part included in the specified kanji, and a kanji part stroke order correct/incorrect display control unit which displays a determination result obtained by the kanji part stroke order determination unit for each kanji part included in the specified kanji.

### BACKGROUND OF THE INVENTION

1. Field of the Invention

The present invention relates to a kanji stroke order learning device, a kanji stroke order learning support method, a kanji stroke order learning system and a recording medium in which a kanji stroke order learning program is recorded.

2. Description of Related Art

Conventionally, in a device such as a tablet type personal computer, an image (hereinafter referred to as a stroke order layout image) wherein images showing individual strokes of a kanji are laid out as one group is to be displayed when a user intends to learn the stroke order of a kanji (for example, see JP 2005-250936). In the technical area of such device, there has been suggested a technique for determining whether the stoke order is correct or incorrect with respect to a kanji written by a user (for example, see JP 1997-222846).

With respect to kanji, many of the kanji are formed by a plurality of radicals being combined, and each radical has its own stroke order.

### SUMMARY OF THE INVENTION

In the conventional techniques, a user cannot learn the stroke order by focusing on the radicals of a kanji.

An object of the present invention is to provide a kanji stroke order learning device, a kanji stroke order learning support method and a kanji stroke order learning system by which a user can learn the stoke order of a kanji by focusing on the radicals and such like that constitute the kanji, and to provide a recording medium in which a kanji stroke order learning program is recorded.

In order to solve the above problems, the first aspect of the present invention provides a kanji stroke order learning device including a kanji part stroke order storage unit which stores a plurality of stroke order data of kanji parts, each kanji part including at least one radical, a kanji part combination storage unit which stores kanji and kanji parts included in the kanji in association to each other, a kanji specifying unit which specifies any kanji as a specified kanji based on an operation performed by a user, a stroke order input unit which inputs stroke order of the specified kanji based on an operation performed by a user, a kanji part stroke order determination unit which determines whether the stroke order of the specified kanji input by the stroke order input unit is correct or incorrect for each kanji part included in the specified kanji by reading out kanji parts included in the specified kanji from the kanji part combination storage unit and by reading out stroke order of each of the read kanji parts from the kanji part stroke order storage unit, and a kanji part stroke order correct/incorrect display control unit which displays a determination result obtained by the kanji part stroke order determination unit for each kanji part included in the specified kanji.

According to the present invention, a user can learn the stroke order of a kanji by focusing on the radicals and such alike that constitute the kanji.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an outer appearance of a display terminal;

FIG. 2 is a block diagram showing a functional configuration of the display terminal;

FIG. 3 is a flowchart showing a flow of a kanji learning process;

FIG. 4 is a flowchart showing the flow of the kanji learning process;

FIG. 5 is a flowchart showing the flow of the kanji learning process;

FIG. 6 is a flowchart showing flows of a practice mode process, a test mode with kanji display process and a test mode without kanji display process;

FIG. 7 is a flowchart showing a flow of an error display process;

FIG. 8A shows contents displayed on a display;

FIG. 8B shows contents displayed on a display;

FIG. 8C shows contents displayed on a display;

FIG. 8D shows contents displayed on a display;

FIG. 9A shows contents displayed on a display;

FIG. 9B shows contents displayed on a display;

FIG. 10A shows contents displayed on a display;

FIG. 10B shows contents displayed on a display;

FIG. 10C shows contents displayed on a display;

FIG. 10D shows contents displayed on a display;

FIG. 11A shows contents displayed on a display;

FIG. 11B shows contents displayed on a display;

FIG. 11C shows contents displayed on a display;

FIG. 11D shows contents displayed on a display; and

FIG. 12 is a block diagram showing a functional configuration of a kanji stroke order learning system including a terminal device and a server device which are connected via a network.

### DESCRIPTION OF THE PREFERRED EMBODIMENT

Hereinafter, details of an embodiment where a kanji stroke order learning device of the present invention is applied as a display terminal will be described with reference to the drawings. However, the scope of the invention is not limited to the examples shown in the drawings.

### 1. OUTER APPEARANCE

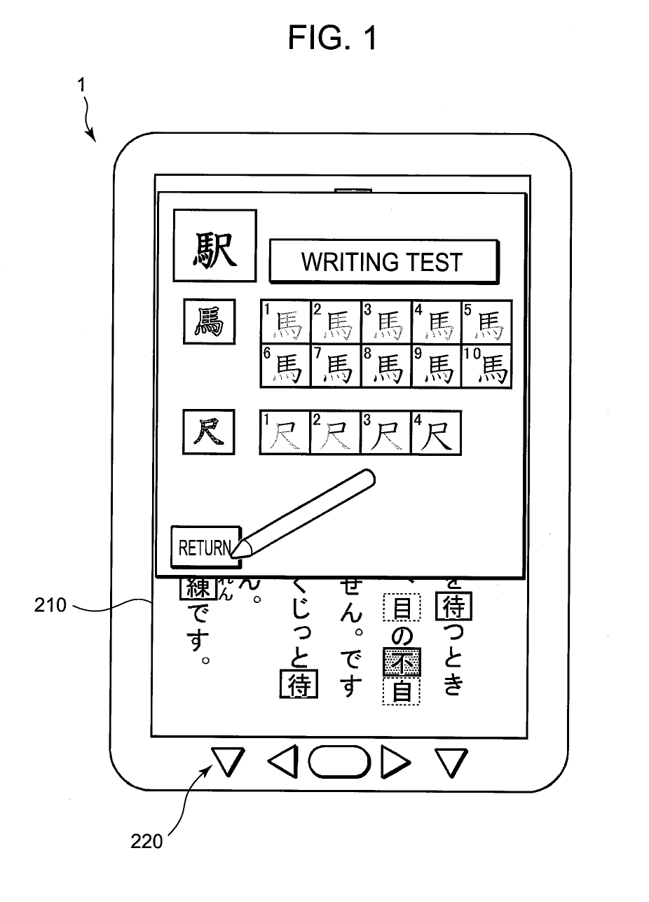

FIG. 1 is a flat view of a display terminal 1.

As shown in FIG. 1, the display terminal 1 includes a display 210 and a group of keys 220.

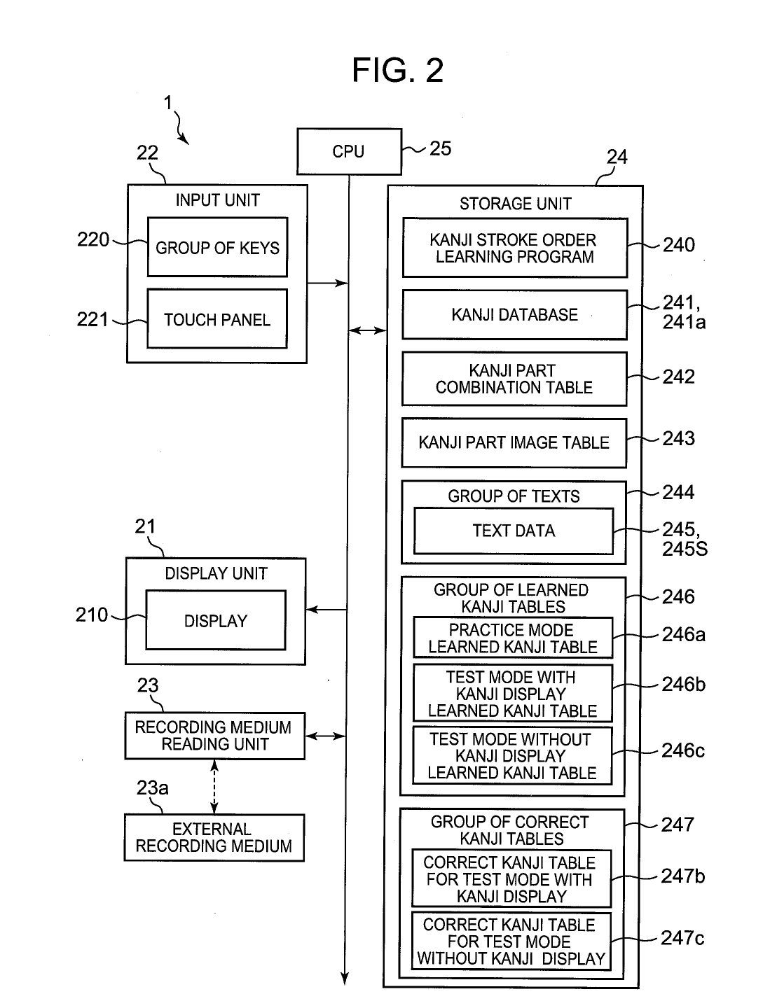

The display 210 is a part where various data such as letters and symbols corresponding to operations performed on the group of keys 220 by a user are displayed. The display 210 is formed of LCD (Liquid Crystal Display) or ELD (Electronic Luminescence Display), for example. The display 210 of the embodiment is formed integrally with a so-called touch panel 221 (see FIG. 2) and can receive operations such as handwriting input and such like.

The group of keys 220 includes various types of keys for receiving user's operations to operate the display terminal 1.

### 2. INTERNAL CONFIGURATION

FIG. 2 is a block diagram showing an internal configuration of the display terminal 1 of the embodiment.

As shown in FIG. 2, the display terminal 1 of the embodiment includes a display unit 21, an input unit 22, a recording medium reading unit 23, a storage unit 24, a CPU 25 and others.

The display unit 21 includes the display 210, and various information are displayed in the display 210 according to display signals which are input from the CPU 25.

The input unit 22 includes the above mentioned group of keys 220, touch panel 221 and others, and signals corresponding to the type of the key which is pushed and the position in the touch panel 221 are output to the CPU 25.

The recording medium reading unit 23 reads out information in an external recording medium 23a such as a SD card and records the information on the external recording medium 23a.

The storage unit 24 is a memory for storing programs and data for realizing various types of functions of the display terminal 1 and which functions as a working area for the CPU 25. In the embodiment, a kanji stroke order learning program 240, a kanji database 241, a kanji part combination table 242, a kanji part image table 243, a group of texts 244, a group of learned kanji tables 246, a group of correct kanji tables 247 and others are stored in the storage unit 24.

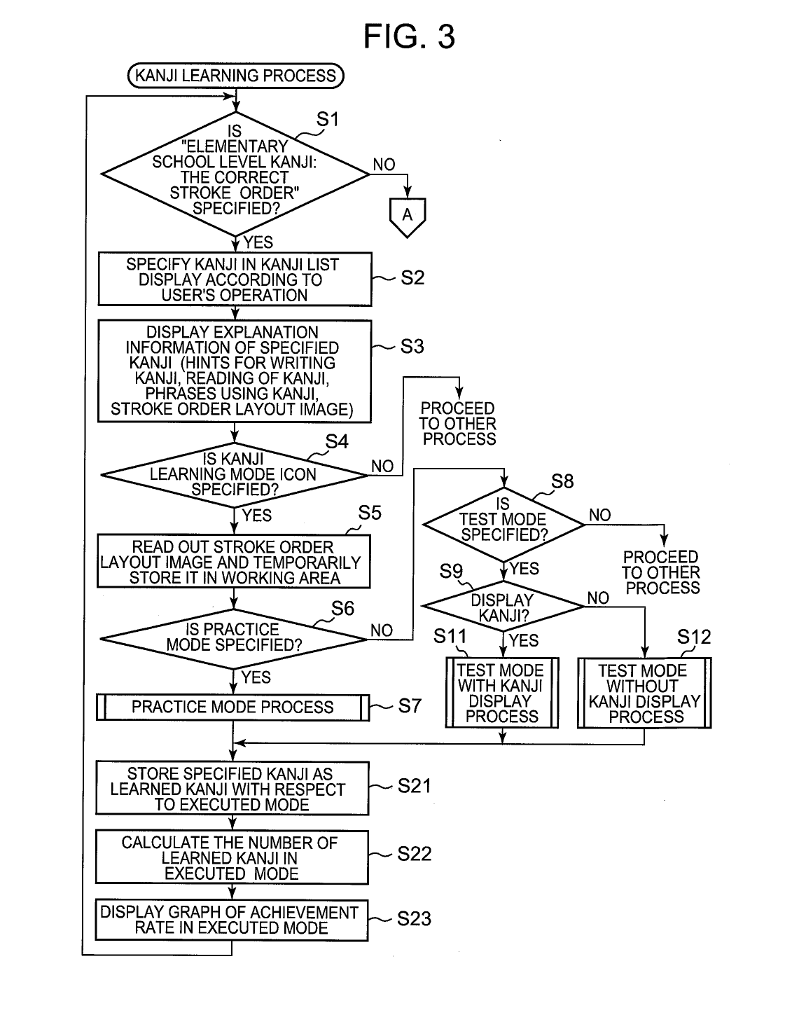

The kanji stroke order learning program 240 is a program to make the CPU 25 execute the after-mentioned kanji learning process (see FIGS. 3 to 5).

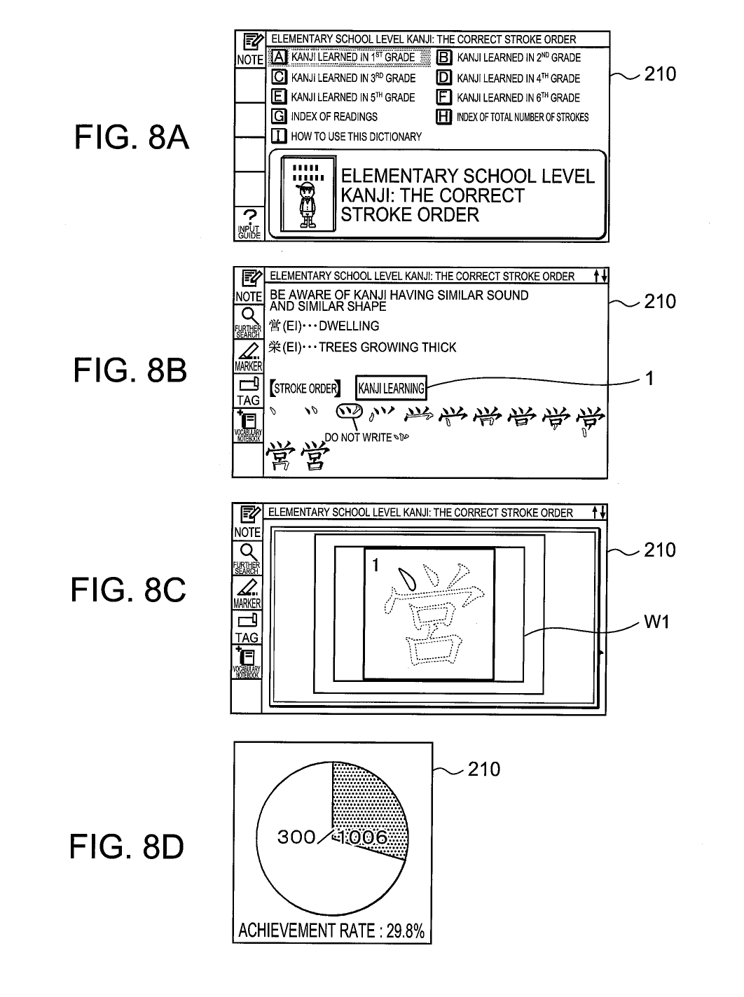

In the kanji database 241, a plurality of kanji and their respective explanation information are stored in association to each other. Here, as the explanation information of a kanji, hints for writing the kanji, reading of the kanji, phrases using the kanji, a stroke order layout image of the kanji and such like are used. Here, the stroke order layout image of a kanji includes images of individual strokes of a kanji (hereinafter, referred to as “n^{th}” stroke image, “n” being a natural number) as one group, for example, as shown in the lower part of FIG. 8B. In particular, for each “n^{th}” stroke image, the value of “n” is displayed in the upper left corner and the entire image of the kanji is shown in gray (or in white (colorless)), the strokes up to “n−1^{th}” stroke from the first stroke of the kanji are distinguished by being displayed in black and the “n^{th}” stroke is distinguished by being displayed in red as shown in FIGS. 8B and 8C. Further, in each “n^{th}” stroke image, the inputting direction (the direction from the start point to the end point) of the “n^{th}” stroke is associated. In the stroke order image shown in FIG. 8B, the strokes from the first stroke to the “n−1^{th}” stroke of the kanji are distinguished by being displayed in black, the “n^{th}” stroke is distinguished by being displayed in red and the entire image of the kanji (rest of the strokes) is shown in white (colorless). In the stroke order image shown in FIG. 8C, the strokes from the first stroke to the “n−1^{th}” stroke of the kanji are distinguished by being displayed in black, the “n^{th}” stroke is distinguished by being displayed in red and the entire image of the kanji (rest of the strokes) is shown in gray. Moreover, in the embodiment, the kanji database 241a of “Elementary school level kanji: the correct stroke order” is used as the kanji database 241, and the kanji to be learned in elementary school are included in the kanji database 241a.

In the kanji part combination table 242, a plurality of kanji, combinations of radicals included in the kanji and inputting orders of the kanji parts are stored in association with one another. Here, kanji parts include groups of a plurality of kanji radicals and combinations of strokes of radicals and parts other than radicals (for example, the kanji part “ [symbol] ” which is the combination of strokes of the radical ( [symbol] ) and the right flick “ [symbol] ”) in addition to kanji radicals.

In the kanji part image table 243, the stroke order layout image (stroke order data) of each kanji part which could be included in a kanji is stored.

The group of texts 244 includes a plurality of text data 245 which are to be used as teaching material.

The group of learned kanji tables 246 includes a practice mode learned kanji table 246a, a test mode with kanji display learned kanji table 246b and a test mode without kanji display learned kanji table 246c.

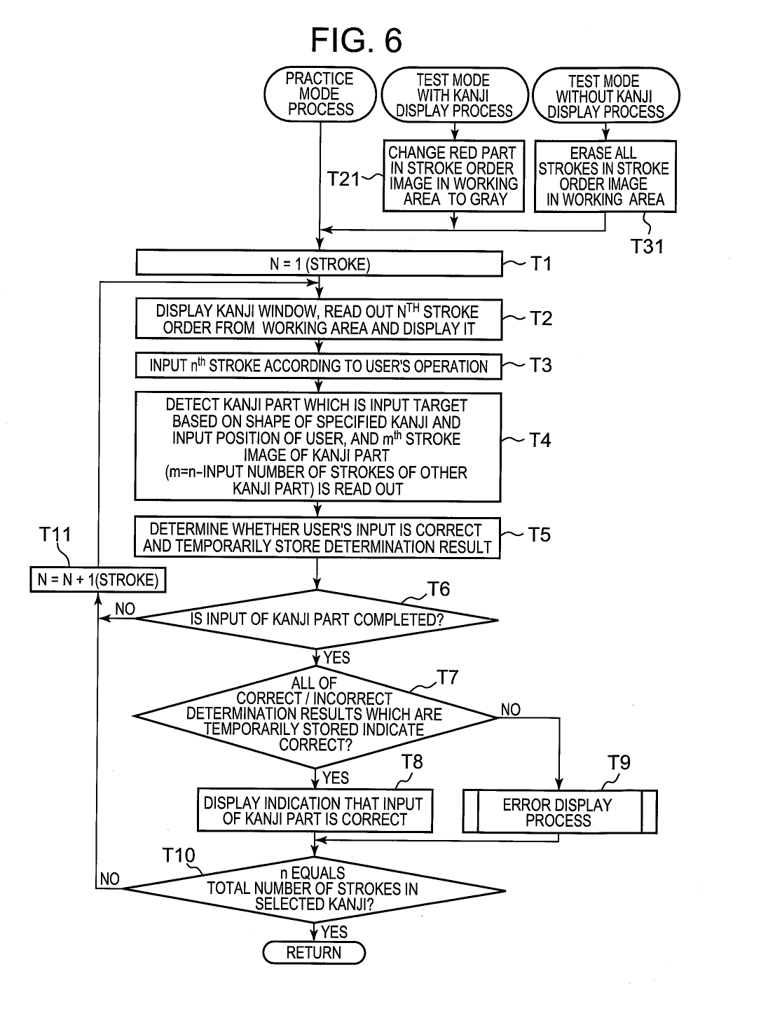

If the after-mentioned practice mode process (see FIG. 6) is executed when a user intends to learn the stroke order of a kanji, the kanji which is target for learning in the process is to be accumulated and stored in the practice mode learned kanji table 246a as a learned kanji.

If the after-mentioned test mode with kanji display process (see FIG. 6) is to be executed when a user intends to learn the stroke order of a kanji, the kanji which is target for learning in the process is to be accumulated and stored in the test mode with kanji display learned kanji table 246b as a learned kanji.

If the after-mentioned test mode without kanji display process (see FIG. 6) is to be executed when a user intends to learn the stroke order of a kanji, the kanji which is target for learning in the process is to be accumulated and stored in the test mode without kanji display learned kanji table 246c as a leaned kanji.

The group of correct kanji tables 247 includes a correct kanji table 247b for test mode with kanji display and a correct kanji table 247c for test mode without kanji display.

If the after-mentioned test mode with kanji display process (see FIG. 6) is executed when a user intends to learn the stroke order of a kanji and if the user inputs the correct stroke order for all the strokes of the kanji in the process, the kanji is to be accumulated and stored in the correct kanji table 247b for test mode with kanji display.

If the after-mentioned test mode without kanji display process (see FIG. 6) is executed when a user intends to learn the stroke order of a kanji and if the user inputs the correct stroke order for all the strokes of the kanji in the process, the kanji is to be accumulated and stored in the correct kanji table 247c for test mode without kanji display.

The CPU 25 performs central controlling of components in the display terminal 1. In particular, the CPU 25 executes various types of processes by opening specified programs among the system program and various types of application programs stored in the storage unit 24 and by cooperating with the opened programs.

### 3. KANJI LEARNING PROCESS

Next, the kanji learning process which is executed by the display terminal 1 will be described with reference to the drawings.

FIGS. 3 to 5 are flowcharts for explaining the operation of the kanji learning process. When an execution instruction of the kanji learning process is input by a user via the input unit 22, the kanji learning process is executed by the kanji stroke order learning program 240 and the CPU 25 cooperating with each other as a result of the kanji stroke order learning program 240 being read out from the storage unit 24 and opened appropriately.

As shown in FIG. 3, in the kanji learning process, the CPU 25 first determines whether an operation for specifying the kanji database 241a of “Elementary school level kanji: the correct stroke order” as the learning target is performed (step S1).

If the CPU 25 determines that the operation for specifying the kanji database 241a as the learning target is performed in step S1 (step S1; YES), the CPU 25 displays the list of kanji included in the kanji database 241a in the display 210 and specifies any one kanji as the specified kanji based on a user's operation (step S2).

Next, the CPU 25 reads out the explanation information of the specified kanji from the kanji database 241a and displays the information in the display 210 (step S3).

Then, the CPU 25 displays the kanji learning mode icon I (see FIG. 8B) in the display 210 and determines whether a touch operation is carried out with respect to the kanji learning mode icon I (step S4). If the CPU 25 determines that the touch operation is not carried out (step S4; No), the CPU 25 proceeds to another process.

IF the CPU 25 determines that the touch operation is carried out with respect to the kanji learning mode icon I in step S4 (step S4; Yes), the CPU 25 temporarily stores the stroke order layout image of the specified kanji in the working area in the storage unit 24 (step S5).

Next, the CPU 25 determines whether an operation for specifying the practice mode is performed (step S6). If the CPU 25 determines that the operation for specifying the practice mode is performed (step S6; Yes), the practice mode process is executed (step S7).

In particular, in the practice mode process, the CPU 25 first sets the value of stroke number “N” to “1” as shown in FIG. 6 (step T1).

Next, the CPU 25 makes the display 210 display the kanji window W1 (see FIG. 8C) and extracts the “N^{th}” stroke image (the image where strokes from the first stroke to the “N^{th}” stroke of the specified kanji are input) from the stroke order layout image which is temporarily stored in the working area in the storage unit 24 and displays the “N^{th}” stroke image in the kanji window W1 (step T2).

Then, the CPU 25 inputs the “N^{th}” stroke in the kanji window W1 based on a user's operation (step T3). By the step T3 being repeated as described later, the strokes of the specified kanji are input. Here, if the running process is the practice mode process at this time and not the after-mentioned test mode with kanji display process nor the test mode without kanji display process, the part distinguished by being displayed in red in the stroke order image displayed in the kanji window W1, that is, the model part for the “N^{th}” stroke is traced by a user to input the “N^{th}” stroke.

Next, the CPU 25 detects a kanji part which is input target on the basis of the shape of the specified kanji and the position where a user input a stroke (the kanji part that is being input) and reads out the “m^{th}” stroke image (m=n−strokes of other kanji parts which are already input) of the kanji part from the kanji part image table 243 (step T4). Here, the inputting direction of the “m^{th}” stroke is associated with the read stroke order image.

Then, the CPU 25 determines whether the input range and the inputting direction of the stroke input by a user are correct or incorrect on the bases of the stroke order image which is read out, and temporarily stores the determination results in the storage unit 24 (step T5).

Next, the CPU 25 reads out the kanji parts included in the specified kanji from the kanji part combination table 242 and determines whether input of any one of the kanji parts in the specified kanji is completed (step T6).

If the CPU 25 determines that the input of the kanji part is not completed (step T6; No), the CPU 25 adds “1” to the value of stroke number “N” (step T11), and thereafter, proceeds to the above described step T2.

If the CPU 25 determines that the input of the kanji part is completed in step T6 (step T6; Yes), the CPU 25 determines whether the correct/incorrect determination results that are temporarily stored in the storage unit 24 all indicate correct with respect to the kanji part which is input target detected in step T4, that is, the CPU 25 determines whether the stroke order of the kanji part is correct (step T7). In such way, the stroke order of the specified kanji is determined by each kanji part included in the specified kanji. Further, in step T7, the CPU 25 reads out the input order of the kanji parts included in the specified kanji from the kanji part combination table 242 and determines whether the input order of the kanji parts are correct.

If the CPU 25 determines that the stroke order of the kanji part is correct in step T7 (step T7; Yes), the CPU 25 makes the display 210 display an indication that the stroke order of the kanji part is correct. Then, the CPU 25 resets the correct/incorrect determination results that are temporarily stored in the storage unit 24 with respect to the kanji part which is input target detected in step T4 (step T8) and proceeds to the after-mentioned step T10. Due to step T8, the determination results of the stroke order of the specified kanji (determination result indicating that the stroke order is correct) are to be displayed in units of a kanji part included in the specified kanji. In step T8, the CPU 25 makes the display 210 display the determination result of the input order of the kanji parts.

If the CPU 25 determines that the stroke order of the kanji part is not correct in step T7 (step T7; No), the CPU 25 carries out the error display process (step T9).

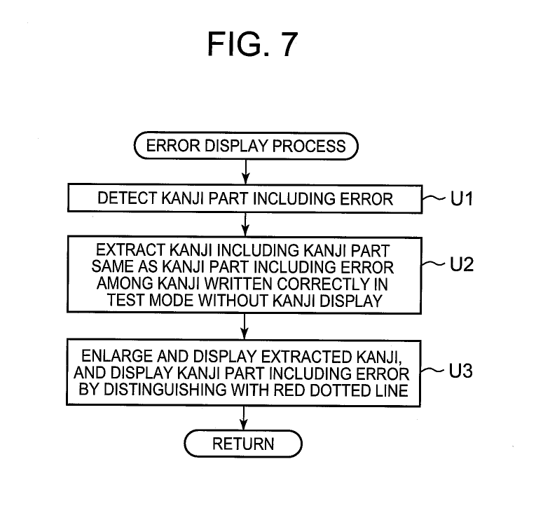

In particular, in the error display process, the CPU 25 first detects the kanji part that includes a part that was input with incorrect stroke order (step U1) and then extracts a kanji which includes the kanji part detected in step U1 and which is different from the specified kanji from the kanji stored in the correct kanji table 247c for test mode without kanji display (the kanji which was correct in the stroke order test in the test mode without kanji display process) (step U2) as shown in FIG. 7. Then, the CPU 25 enlarges the extracted kanji, makes the display 210 display the enlarged kanji and displays the kanji part detected in step U1 among the kanji parts included in the kanji so as to distinguish the kanji part by enclosing it with red dotted line (step U3). Thereby, the error display process ends. By the error display process, the determination result (the determination result indicating that the stroke order is incorrect) of the stroke order of the specified kanji is to be displayed for each kanji part included in the specified kanji. Further, in step U3, the CPU 25 makes the display 210 display the determination result of the input order of the kanji parts and resets the correct/incorrect determination results that are temporarily stored in the storage unit 24 with respect to the kanji part which is input target detected in step T4.

When the above error display process ends, next, the CPU 25 determines whether the value of stroke number “N” is equal to the total number of strokes in the specified kanji (step T10) as shown in FIG. 6. If the CPU 25 determines that the value of stroke number “N” is not equal to the total number of strokes of the specified kanji (step T10; No), the CPU 25 proceeds to the above mentioned step T11.

If the CPU 25 determines that the value of stroke number “N” is equal to the total number of strokes in the specified kanji in step T10 (step T10; Yes), the CPU 25 ends the practice mode process and proceeds to the after-mentioned step S21 as shown in FIG. 3.

If the CPU 25 determines that the operation for specifying the practice mode is not performed in step S6 (step S6; No), the CPU 25 determines whether an operation for specifying the test mode is performed (step S8).

If the CPU 25 determines that an operation for specifying the test mode is not performed in step S8 (step S8; No), the CPU 25 proceeds to another process.

If the CPU 25 determines that an operation for specifying the test mode is performed in step S8 (step S8; Yes), the CPU 25 determines whether an operation for displaying a kanji image as a hint for a test is to be displayed (step S9).

If the CPU 25 determines that an operation for displaying a kanji image is performed in step S9 (step S9; Yes), the CPU 25 carries out the test mode with kanji display process (step S11).

In particular, in the test mode with kanji display process, the CPU 25 first changes each part that is distinguished by being displayed in red in the stroke order layout image which is temporarily stored in the working region in the storage unit 24 to gray (step T21) and proceeds to step T1 as shown in FIG. 6. In such way, in each stroke order image, the next stroke to be input is not displayed. In particular, for example, in the “N^{th}” stroke image, the strokes from the “first” stroke to the “N−1^{th}” stroke are all shown in black and the “N^{th}” stroke and the strokes thereafter are shown in gray. In a case where the entire kanji is shown in white color (colorless) and not in gray in each stroke image, the CPU 25 may erase the parts distinguished by being displayed in red.

In such way, by performing the above steps T1 to T10 in a state where the next stoke to be input is not distinguished, stroke order images relating to the specified kanji are displayed as hints and the stroke order test is to be presented to a user, and the test mode with kanji display process ends.

If the CPU 25 determines that an operation for displaying a kanji image is not performed in step S9 (step S9; No), the CPU 25 carries out the test mode without kanji display process as shown in FIG. 3 (step S12).

In particular, in the test mode without kanji display process, the CPU 25 erases all of the strokes in the stroke order layout image which is temporarily stored in the working area in the storage unit 24 (step T31) and then proceeds to step T1 as shown in FIG. 6.

In such way, by the steps T1 to T10 being performed in a state where all of the strokes are erased, hints in the stroke order images relating to the specified kanji are not to be displayed and the stroke order test is to be presented to a user, and the test mode without kanji display process ends.

When the practice mode process, the test mode with kanji display process and the test mode without kanji display process are ended, the CPU 25 next stores the specified kanji, as a learned kanji, in the kanji table corresponding to the executed process among the practice mode learned kanji table 246a, the test mode with kanji display learned kanji table 246b and the test mode without kanji display learned kanji table 246c (step S21) as shown in FIG. 3. In a case where the test mode with kanji display process or the test mode without kanji display process is ended and if it is determined that a user correctly input the stroke order of the specified kanji as a whole in the process, the CPU 25 stores the specified kanji in the kanji table corresponding to the executed process among the test mode with kanji display learned kanji table 246b and the test mode without kanji display learned kanji table 246c in step S21.

Next, the CPU 25 calculates the number of learned kanji stored in the kanji table corresponding to the executed process among the practice mode learned kanji table 246a, the test mode with kanji display learned kanji table 246b and the test mode without kanji display learned kanji table 246c (step S22), and the CPU 25 makes the display 210 display the number of learned kanji with respect to the number of kanji included in the kanji database 241a in the form of a pie chart (step S23), and thereafter, the CPU 25 proceeds to step S1.

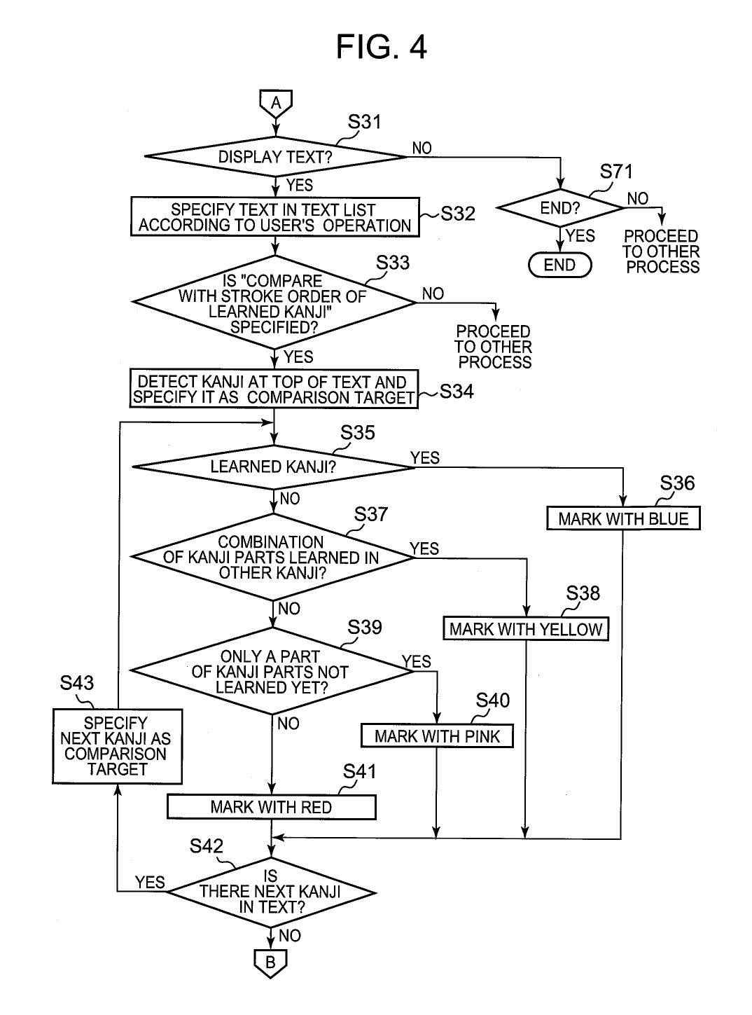

If the CPU 25 determines that an operation for specifying the kanji database 241a as the learning target is not performed in step S1 (step S1; No), the CPU 25 determines whether an operation for displaying any of text data 245 in the text group 244 is performed (step S31) as shown in FIG. 4.

If the CPU 25 determines that an operation for displaying any text data 245 in the text group 244 is performed in step S31 (step S31; Yes), the CPU 25 displays a list of titles of text data 245 in the text group 244 in the display 210 and specifies any text data 245 as the specified text data 245S based on a user's operation (step S32).

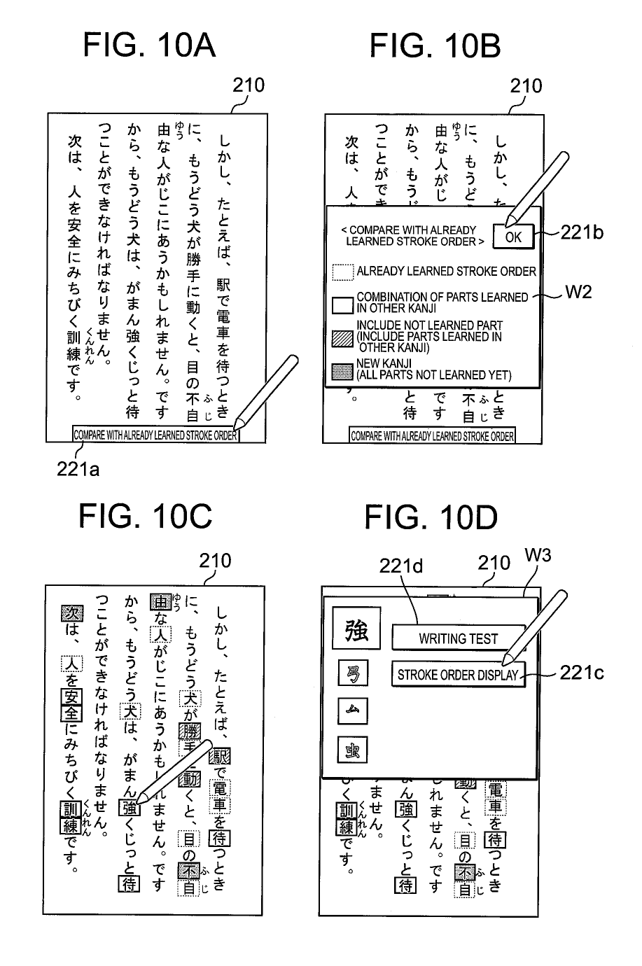

Next, the CPU 25 makes the display 210 display the specified text data 245S and a soft key (hereinafter, referred to as the comparison key 221a; see FIG. 10A) for comparing the stroke order of the learned kanji and the stroke order of the kanji in the specified text data 245S. Then, the CPU 25 determines whether the comparison key 221a is operated (step S33). If the CPU 25 determines that the comparison key 221a is not operated (step S33; No), the CPU 25 proceeds to another process.

If the CPU 25 determines that the comparison key 221a is operated in step S33 (step S33; Yes), the CPU 25 detects the first kanji in the specified text data 245S and specifies the first kanji as the kanji target for comparison (hereinafter, referred to as the comparison target kanji) (step S34).

Next, the CPU 25 determines whether the comparison target kanji is stored in any table in the group of learned kanji tables 246 as a learned kanji (step S35).

If the CPU 25 determines that the comparison target kanji is stored in any table in the group of learned kanji tables 246 as a learned kanji in step S35 (step S35; Yes), the CPU 25 marks and displays the comparison target kanji in blue (step S36) and proceeds to step S42.

If the CPU 25 determines that the comparison target kanji is not stored in any table in the group of learned kanji tables 246 as a learned kanji in step S35 (step S35; No), the CPU 25 referrers to the kanji part combination table 242 and determines whether the comparison target kanji is a combination of kanji parts included in the learned kanji in the group of learned kanji tables 246 (step S37).

If the CPU 25 determines that the comparison target kanji is a combination of kanji parts included in the learned kanji in the group of learned kanji tables 246 in step S37 (step S37; Yes), the CPU 25 marks and displays the comparison target kanji in yellow (step S38) and proceeds to step S42.

If the CPU 25 determines that the comparison target kanji is not a combination of kanji parts included in the leaned kanji in step S37, that is, if the CPU 25 determines that at least a part of kanji parts in the comparison target kanji is not included in the learned kanji (step S37; No), the CPU 25 determines whether a part of kanji parts in the comparison target kanji is not yet learned (only a part of kanji parts in the comparison target kanji is not included in the learned kanji in the group of learned kanji tables 246) (step S39).

If the CPU 25 determines that only a part of kanji parts in the comparison target kanji is not yet learned in step S39 (step S39; Yes), the CPU 25 marks and displays the comparison target kanji in pink (step S40) and proceeds to step S42.

If the CPU 25 determines that not only a part of kanji parts in the comparison target kanji is not learned yet in step S39, that is, if all of the kanji parts in the comparison target kanji are not learned yet (all of the kanji parts in the comparison target kanji are not included in the learned kanji in all of the tables in the group of learned kanji tables 246) (step S39; No), the CPU 25 marks and displays the comparison target kanji in red (step S41).

Next, the CPU 25 determines whether there is a kanji after the current comparison target kanji in the specified text data 245S (step S42). If the CPU 25 determines that there is a kanji after the current comparison target kanji in the specified text data 245a (step S42; Yes), the CPU 25 re-specifies the kanji that is after the current comparison target kanji as the new comparison target kanji (step S43) and proceeds to step S35.

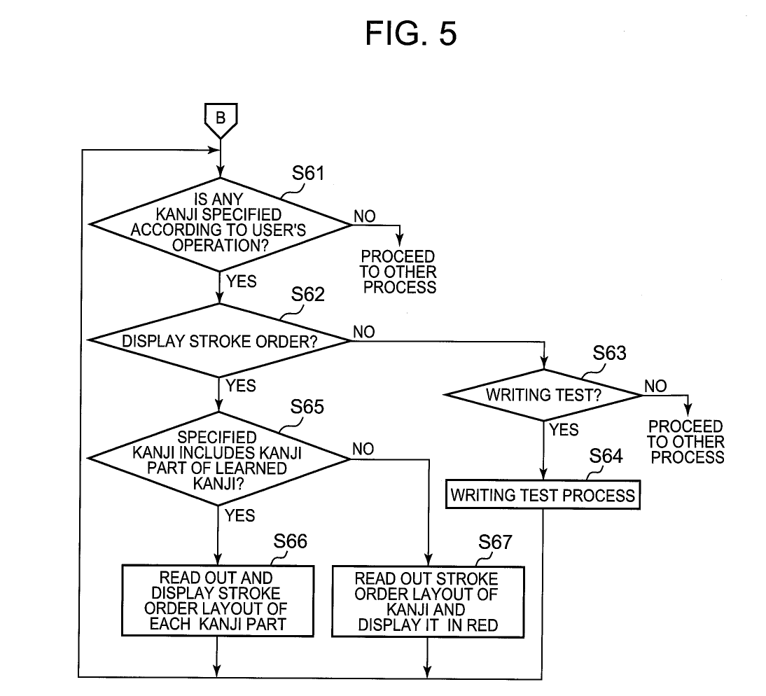

If the CPU 25 determines that there is no kanji after the current comparison target kanji in the specified text data 245a (step S42; No), the CPU 25 determines whether a specifying operation is performed with respect to any kanji in the specified text data 245S (step S61) as shown in FIG. 5.

If the CPU 25 determines that a specifying operation is not performed with respect to any of the kanji in step S61 (step S61; No), the CPU 25 proceeds to another process.

If the CPU 25 determines that a specifying operation is performed with respect to any of the kanji in step S61 (step S61; Yes), the CPU 25 reads out the kanji parts in the kanji which is specified (hereinafter, referred to as the specified kanji) from the kanji part combination table 242, makes the display 210 display the confirmation window W3 (see FIG. 10D) including the specified kanji and the kanji parts thereof and determines whether an operation for displaying the stroke order of the specified kanji is performed (step S62). Here, in step S62, among the kanji parts displayed in the confirmation window W3, the CPU 25 displays the kanji parts included in the learned kanji stored in any of the tables in the group of learned kanji tables 246 by distinguishing in blue and displays the unlearned kanji parts which are not included in any of the learned kanji by distinguishing in red.

If the CPU 25 determines that an operation for displaying the stroke order of the specified kanji is performed in step S62 (step S62; Yes), the CPU 25 determines whether the kanji parts of other learned kanji are included in the specified kanji, that is, whether the specified kanji is marked and displayed in yellow or pink (step S65).

If the CPU 25 determines that the kanji parts of other learned kanji are included in the specified kanji in step S65 (step S65; Yes), the CPU 25 reads out the stroke order layout image of the kanji part(s) included in the specified kanji from the kanji part image table 243 and displays the stroke order layout image in the confirmation window W3 (step S66). Then, the CPU 25 proceeds to step S61. At this time, the CPU 25 displays the kanji part(s) included in the learned kanji by distinguishing in blue and displays the unlearned kanji part(s) which is not included in the learned kanji by distinguishing in red.

If the CPU 25 determines that the kanji parts of other learned kanji are not included in the specified kanji in step S65 (step S65; No), the CPU 25 reads out the stroke order layout image of the specified kanji from the kanji database 241 and displays the read out stroke order layout image in the confirmation window W3 (step S67). Then, the CPU 25 proceeds to step S61. At this time, the CPU 25 displays the specified kanji in the confirmation window W3 in red.

If the CPU 25 determines that an operation for displaying the stroke order of the specified kanji is not performed in step S62 (step S62; No), the CPU 25 determines whether an operation for carrying out a kanji writing test is performed (step S63).

If the CPU 25 determines that an operation for carrying out a kanji writing test is not performed in step S63 (step S63; No), the CPU 25 proceeds to another process.

If the CPU 25 determines that an operation for carrying out a kanji writing test is performed in step S63 (step S63; Yes), the CPU 25 performs the writing test process (step S64) and proceeds to step S61. In step S64, the CPU 25 carries out processes similar to those of steps S12 and S21.

If the CPU 25 determines that an operation for displaying any of text data 245 in the text group 244 is not performed in step S31 (step S31; No), the CPU 25 determines whether the ending operation is performed (step S71) as shown in FIG. 4.

If the CPU 25 determines that the ending operation is not performed in step S71 (step S71; No), the CPU 25 proceeds to another process. If the CPU 25 determines that the ending operation is performed (step S71; Yes), the kanji learning process ends.

### 4. OPERATION EXAMPLE

Next, a specific operation of the display terminal 1 will be described with reference to the drawings.

### Operation Example 1

First, as shown in FIGS. 8A and 8B, when a user specifies the kanji database 241a of “Elementary school level kanji: the correct stroke order” as the learning target (step S1; Yes) and specifies “ [symbol] ” which is a kanji included in the kanji database 241a as the specified kanji (step S2), the explanation information on the specified kanji “ [symbol] ” is read out from the kanji database 241a and displayed in the display 210 (step S3).

Next, when the kanji learning mode icon I is displayed in the display 210 and a user performs a touch operation with respect to the kanji learning mode icon I (step S4; Yes), the stroke order layout image of the specified kanji “ [symbol] ” is temporarily stored in the working area in the storage unit 24 (step S5).

When a user performs an operation for specifying the practice mode (step S6; Yes), the practice mode process is executed (step S7) and “1” is set to the value of stroke number “N” (step T1).

Next, the kanji window W1 is displayed in the display 210 and the “N^{th}” stroke image (here “N”=1) is extracted from the stroke order layout image which is temporarily stored in the working area in the storage unit 24 and displayed in the kanji window W1 (step T2).

Next, by tracing the part distinguished by being displayed in red in the stroke order image displayed in the kanji window W1, that is, the model part of the “N^{th}” stroke, a user inputs the “N^{th}” stroke (here “N”=1) in the kanji window W1 (step T3).

Then, a kanji part which is input target (here, the crown radical) is detected based on the specified kanji “ [symbol] ” and the input position of the user's stroke, and the “m^{th}” stroke image of the kanji part (here, “m”=1) is read out from the kanji part image table 243 (step T4).

Next, on the basis of the stroke order image which is read out, correct/incorrect of the input range and the inputting direction of the stroke input by a user are determined and the determination results (determination results indicated that they are correct) are temporarily stored in the storage unit 24 (step T5).

Then, the kanji part included in the specified kanji “ [symbol] ” (here, the crown radical) is read out from the kanji part combination table 242. If it is determined that input of the kanji part is not completed in the specified kanji (step T6; No), “1” is added to the value of stroke number “N” (step T11).

Similarly, hereinafter, the stroke image (here, “N”=2, 3 . . . ) is extracted from the stroke order layout image which is temporarily stored in the working area in the storage unit 24 and is displayed in the kanji window W1 (step T2), and a user inputs the “N^{th}” stroke (here, “N”=2, 3, . . . ) in the kanji window W1 (step T3). Next, the kanji part which is the input target (here, the crown radical) is detected based on the shape of the specified kanji “ [symbol] ” and the input position of the user's stroke and the “m^{th}” stroke image of the kanji part (here, “m”=2, 3, . . . ) is read out from the kanji part image table 243 (step T4). Then, based on the stroke order image which is read out, correct/incorrect of the input range and inputting direction of the stroke input by the user are determined, and the determination results (determination results indication that they are correct) are temporarily stored in the storage unit 24 (step T5). Then, the kanji part included in the specified kanji “ [symbol] ” (here, the crown radical) is read out from the kanji part combination table 242. If it is determined that the input of the kanji part is completed in the specified kanji (step T6; Yes), whether the correct/incorrect determinations that are temporarily stored in the storage unit 24 relating to the kanji part which is input target are all correct, that is, whether the stroke order of the kanji part is correct is determined (step T7).

If it is determined that the stroke order of the kanji part is correct (step T7; Yes), a display indicating that the stroke order is correct is to be displayed in the display 210 (step T8).

Similarly, hereinafter, a user inputs strokes with regard to other kanji parts, and if the stroke order of each kanji part is determined as being correct (step T7; Yes), a display indicating that the stroke order is correct is to be displayed in the display 210 (step T8).

If it is determined that the value of stroke number “N” is equal to the total number of strokes in the specified kanji (step T10; Yes), the specified kanji “ [symbol] ” is stored in the practice mode learned kanji table 246a as a learned kanji (step S21). Next, the number of learned kanji (here, “300”) stored in the practice mode learned kanji table 246a is calculated (step S22) and a pie chart showing the ratio of the number of learned kanji “300” to the number of kanji included in the kanji database 241a (here, “1006”) is to be displayed in the display 210 (step S23).

### Operation Example 2

Similarly, to the above described operation example 1, first, when a user specifies the kanji database 241a of “Elementary school level kanji: the correct stroke order” as the learning target (step S1; Yes) and specifies the kanji “ [symbol] ” included in the kanji database 241a as the specified kanji (step S2), the explanation information relating to the specified kanji “ [symbol] ” is read out from the kanji database 241a and is displayed in the display 210 (step S3).

Next, the kanji learning mode icon I is displayed in the display 210, and if a user performs a touch operation with respect to the kanji learning mode icon I (step S4; Yes), the stroke order layout image of the specified kanji “ [symbol] ” is to be temporarily stored in the working area in the storage unit 24 (step S5).

When a user performs an operation for specifying the test mode (step S8; Yes) and performs an operation for displaying a kanji image as a hint for the test (step S9; Yes), the test mode with kanji display process is to be executed (step S11), the part distinguished by being displayed in red in the stroke order list image, which is temporarily stored in the working area in the storage unit 24, is changed to be distinguished by being displayed in gray (step T21) and “1” is set to the value of stroke number “N” (step T1).

Similarly to the above described operation example 1, the “N^{th}” stroke image (here, “N”=1) is extracted from the stroke order layout image which is temporarily stored in the working area in the storage unit 24 and is displayed in the kanji window W1 (step T2). In such stroke order image, differently from the stroke order image displayed in the above operation example 1, the stroke that is to be input next is not distinguished.

When a user inputs the “N^{th}” stroke (here, “N”=1) in the kanji window W1 (step T3), the kanji part which is input target (here, the crown radical) is detected based on the shape of the specified kanji “ [symbol] ” and the input position of the user's stroke. Then, the “m^{th}” stroke image (here, “m”=1) of the kanji part is read out from the kanji part image table 243 (step T4), correct/incorrect of the input range and inputting direction of the stroke input by a user are determined based on the stroke order image and the determination results (determination results indicating that they are correct) are temporarily stored in the storage unit 24 (step T5).

Then, the kanji part (here, the crown radical) included in the specified kanji “ [symbol] ” is read out from the kanji part combination table 242, and it is determined that input of the kanji part is not completed in the specified kanji (step T6; No) and “1” is added to the value of the stroke number “N” (step T11).

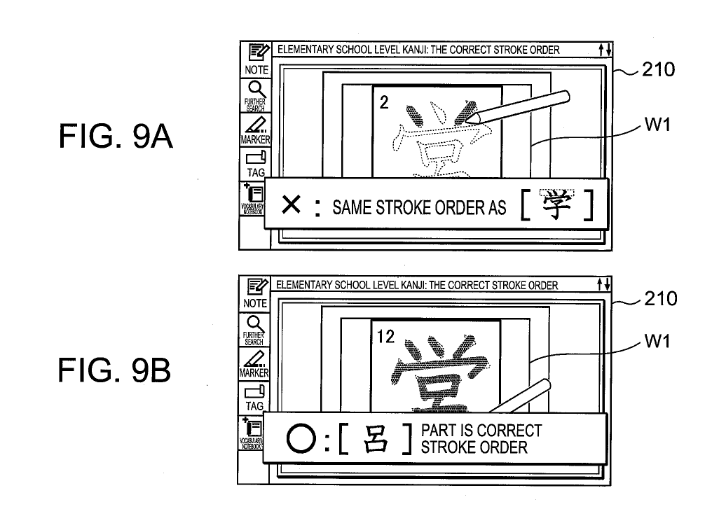

When the “N^{th}” stroke image (here, “N”=2) is extracted from the stroke order layout image which is temporarily stored in the wording area in the storage unit 24 and is displayed in the kanji window U1 (step T2) and when a user incorrectly inputs the “N^{th}” stroke (here, “N”=2) in the kanji window W1 (step T3) as shown in FIG. 9A, the kanji part which is input target (here, the crown radical) is detected based on the shape of the specified kanji “ [symbol] ” and the input position of the user's stroke. Then, the “m^{th}” stroke image (here, “m”=2) of the kanji part is read out from the kanji part image table 243 (step T4), correct/incorrect of the input range and inputting direction of the stroke input by the user are determined based on the stroke order image, and the determination results (determination results indicating that they are incorrect) are to be temporarily stored in the storage unit 24 (step T5).

In such case, when a user inputs the rest of the strokes in the kanji window W1 (step T3) and when it is determined that input of the kanji part (here, the crown radical) included in the specified kanji “ [symbol] ” is completed (step T6; Yes), the stroke order of the kanji part is determined as being incorrect (step T7; No) and the kanji part (here, the crown radical) including a stroke which was input with incorrect stroke order is detected (step U1). Thereafter, the kanji “ [symbol] ” which includes the kanji part (here, the crown radical in “ [symbol] ”) and which is different from the specified kanji “ [symbol] ” is extracted from the kanji stored in the correct kanji table 247c for test mode without kanji display (the kanji that were correctly written in the writing test in the test mode without kanji display process) (step U2). Then, the kanji “ [symbol] ” is enlarged and displayed in the display 210, and the kanji part detected in step U1 (here, the crown radical) among the kanji parts included in the kanji “ [symbol] ” is distinguished by being enclosed with red dotted line (step U3).

On the other hand, if a user correctly inputs the stroke order of the other kanji part (here, the “ [symbol] ” part) in the specified kanji “ [symbol] ” (step T3) and if it is determined that input of the kanji part (here, the “ [symbol] ” part) included in the specified kanji “ [symbol] ” is completed (step T6; Yes) and determined that the stroke order of the kanji part is correct (step T7; Yes), a display indicating that the stroke order of the kanji part is correct is to be displayed in the display 210 as shown in FIG. 9B (step T8).

### Operation Example 3

First, when a user performs an operation for displaying the text data 245 (step S31; Yes) and specifies any text data 245 as the specified text data 245S (step S32), the specified text data 245S is displayed in the display 210 and the comparison key 221a is displayed in the display 210 as shown in FIG. 10A.

Next, when a user operates the comparison key 221a (step S33; Yes), the legend window W2 including a legend indicating in which color each kanji in the specified text data 245S is displayed and an execution key 221b for instructing the execution of marker display is displayed as shown in FIG. 10B in this operation example.

If a use operates the execution key 221b, the first kanji “ [symbol] ” in the specified text data 245S is specified as the comparison target kanji (step S34). Thereafter, it is determined that only a part of kanji parts (here, the kanji part “ [symbol] ”) in the comparison target kanji “ [symbol] ” is not learned yet (not included in the learned kanji in the group of learned kanji tables 246) (step S39; Yes) and the comparison target kanji “ [symbol] ” is to be displayed by being marked with pink as shown in FIG. 10C (step S40).

Then, it is determined that there is the kanji “ [symbol] ” after the current comparison target kanji “ [symbol] ” in the specified text data 245S (step S42; Yes) and the kanji “ [symbol] ” is specified as the new comparison target kanji (step S43). Thereafter, it is determined that the comparison target kanji “ [symbol] ” is stored in the group of learned kanji tables 246 as a learned kanji (step S35; Yes) and the comparison target kanji “ [symbol] ” is displayed by being marked with blue (step S36).

Similarly, hereinafter, the kanji which are stored in the group of learned kanji tables 246 as learned kanji among the kanji in the specified text data 245S are displayed by being marked with blue (step S36). The kanji which are combinations of the kanji parts included in the learned kanji in the group of learned kanji tables 246 are displayed by being marked with yellow (step S38). The kanji in which only a part of the kanji parts is not learned yet (only a part of kanji parts is not included in the learned kanji in the group of learned kanji tables 246) are displayed by being marked with pink (step S40). The kanji in which all of the kanji parts are not yet learned (all of the kanji parts are not included in the learned kanji in the group of learned kanji tables 246) are displayed by being marked with red (step S41).

Next, when a user performs a specifying operation with respect to the kanji “ [symbol] ” in the specified text data 245S (step S61; Yes), the kanji parts in the specified kanji are read out from the kanji part combination table 242 and the confirmation window W3 including the specified kanji “ [symbol] ” and the kanji parts “ [symbol] ”, “ [symbol] ” and “ [symbol] ” is displayed in the display 210 as shown in FIG. 10D. Among the kanji parts “ [symbol] ”, “ [symbol] ” and “ [symbol] ” displayed in the confirmation window W3, the kanji part “ [symbol] ” included in the learned kanji stored in any one table of the group of learned kanji tables 246 is distinguished by being displayed in blue and the kanji parts “ [symbol] ” and “ [symbol] ” which are not included in any of the learned kanji are distinguished by being displayed in red. In this operation example, the stroke order display key 221c for displaying the stroke order of the specified kanji and the writing test key 221d for performing a writing test on the specified kanji are displayed in the confirmation window W3.

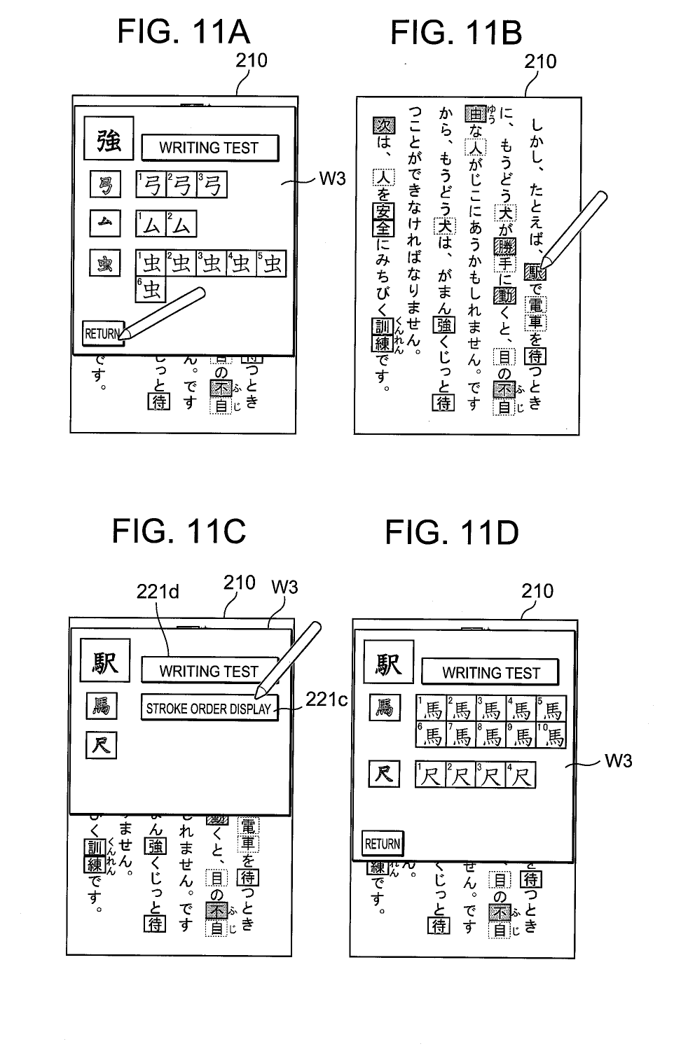

Next, when a user performs an operation for displaying the stroke order of the specified kanji “ [symbol] ” by operating the stroke order display key 221c (step S62; Yes), it is determined that the specified kanji “ [symbol] ” includes the kanji part “ [symbol] ” of other learned kanji (step S65; Yes) and the stroke order layout images of the kanji parts “ [symbol] ”, “ [symbol] ” and “ [symbol] ” included in the specified kanji “ [symbol] ” are read out from the kanji part image table 243 and are displayed in the confirmation window W3 as shown in FIG. 11A (step S66). At this time, the kanji part “ [symbol] ” included in the learned kanji is distinguished by being displayed in blue and the kanji parts “ [symbol] ” and “ [symbol] ” which are not included in the learned kanji are distinguished by being displayed in red.

When a user performs an operation for resetting the display content and thereafter performs the specifying operation with respect to the kanji “ [symbol] ” in the specified text data 245S (step S61; Yes), the kanji parts in the specified kanji are read out from the kanji part combination table 242 and the confirmation window W3 including the specified kanji “ [symbol] ” and the kanji parts “ [symbol] ” and “ [symbol] ” is displayed in the display 210. Further, among the kanji parts “ [symbol] ” and “ [symbol] ” displayed in the confirmation window W3, the kanji part “ [symbol] ” included in the learned kanji stored in any table in the group of learned kanji tables 246 is distinguished by being displayed in blue and the kanji part “ [symbol] ” which is not included in any learned kanji is distinguished by being displayed in red.

Next, when a user performs an operation for displaying the stroke order of the specified kanji “ [symbol] ” by operating the stroke order display key 221c (step S62; Yes), it is determined that the specified kanji “ [symbol] ” includes the kanji part “ [symbol] ” of other learned kanji (step S65; Yes), the stroke order layout images of the kanji parts “ [symbol] ” and “ [symbol] ” included in the specified kanji “ [symbol] ” are read out from the kanji part image table 243 and are displayed in the confirmation window W3 as shown in FIG. 11D (step S66). At this time, the kanji part “ [symbol] ” included in the learned kanji is distinguished by being displayed in blue and the kanji part “ [symbol] ” which is not included in the learned kanji is distinguished by being displayed in red.

According to the embodiment, as shown in steps T1 to T10 of FIG. 6 and FIG. 9, for example, any one kanji is specified as the specified kanji based on a user's operation and the stroke order of the specified kanji is input, the kanji parts included in the specified kanji parts are read out from the kanji part combination table 242 and the stroke order of each of the kanji parts are read out from the kanji part image table 243. Further, with respect to each kanji part included in the specified kanji, whether the stroke order of the specified kanji input by a user is correct or incorrect is determined. The determination result is displayed for each kanji part. Therefore, the stroke order of a kanji can be learned according to each kanji part that constitutes the kanji. Thus, the stroke order of the kanji can be learned by focusing on the radicals which constitute the kanji.

Moreover, as shown in step T7 of FIG. 6, for example, the input order of the kanji parts included in the specified kanji is readout from the kanji part combination table 242, whether the input order of the kanji parts input by a user is correct or incorrect is determined and the determination result is displayed. Therefore, the input order of kanji parts can be learned.

Further, as shown in step S21 of FIG. 3 and FIG. 9A, for example, whether the stroke order of the specified kanji as a whole input by a user is correct or incorrect is determined, and the specified kanji is accumulated and stored in the group of correct kanji tables 247 if the stroke order as a whole is determined as being correct. Further, if the stroke order of any one of the kanji parts included in the specified kanji is determined as being incorrect, a kanji including the kanji part and which is different from the specified kanji is extracted from the kanji stored in the group of correct kanji tables 247 and is displayed. Therefore, in a case where the stroke order of any one of the kanji parts is incorrect, the kanji whose stroke order is already learned, the kanji including the kanji part, is displayed and the stroke order can be confirmed with reference to this kanji.

Moreover, as shown in steps S38 and S40 of FIG. 4, FIG. 10 and FIG. 11, for example, among the kanji in the displayed text, the kanji including the same kanji parts as the kanji stored in the group of learned kanji tables 246 are distinguished. Therefore, even a kanji which a user does not know its stroke order as a whole can be analogized with reference to the stroke order of the kanji part which is already learned.

### Modification Example

Next, a modification example of the embodiment will be described. Here, like symbols are used for the configuration elements which are similar to those in the above embodiment, and the descriptions are omitted.

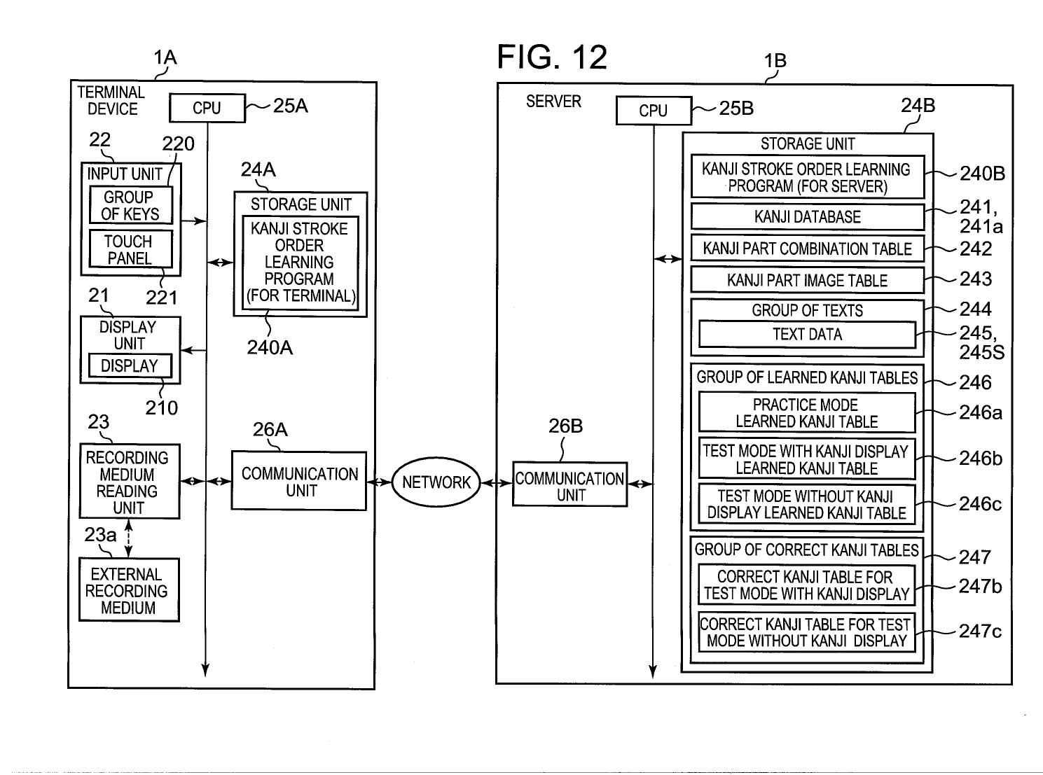

FIG. 12 is a block diagram showing the functional configuration in a case where the processes similar to the above embodiment are to be realized in the kanji stroke order learning system including a terminal device 1A and a server device 1B which are connected via a network.

As shown in FIG. 12, the terminal device 1A includes a communication unit 26A, a CPU 25A and a storage unit 24A. The communication unit 26A performs sending and receiving of information with the server device 1B via the network N. The kanji stroke order learning program 240A is stored in the storage unit 24A and the CPU 25A executes a process according to the kanji stroke order learning program 240A. In particular, data according to a specifying operation and an input operation performed by a user is sent to the server device 1B from the communication unit 26A via the network N and the process result data obtained in the server device 1B is received by the terminal device 1A and is displayed in the display unit 21.

The server device 1B includes a communication 26B, a CPU 25B and a storage unit 24B. The communication unit 26B performs sending and receiving of information with the terminal device 1A via the network N. In the storage unit 24B, various data, table groups and the like including the kanji stroke order learning program 240B and kanji database 241 are stored. Such server device 1B processes various data including the kanji database 241 and data of table groups according to the data input from the terminal device 1A and sends the process results to the terminal device 1A.

In FIG. 12, various data including the kanji database 241 and table groups are stored in the server device 1B. However, a part of database and tables may be stored in the terminal device 1A and a part of processes according to the input operations performed by a user may be performed in the terminal device 1A.

Here, the detail configuration and detail operation of each configuration element of the display terminal 1, the terminal device 1A and the server device 1B in the embodiment and the modification example can be modified arbitrarily within the scope of the invention.

For example, description is given by applying the kanji stroke order learning device of the present invention as the display terminal 1. However, the present invention is not limited to be applied to such products, and can be applied generally to electronic devises such as scientific electronic calculators, cellular phones, personal computers, PDAs (Personal Digital Assistant) and game devises. The kanji stroke order learning program 240 according to the present invention can be stored in a memory card, a CD or such like which can be detached from the display terminal 1.

Further, the above description describes a case where a user inputs the stroke order of a kanji by inputting the strokes by hand. However, the strokes may be input by a user touching the stroke parts in the displayed kanji in order.

Although several embodiments of the present invention are described above, they do not limit the present invention and the scope of the present invention includes the scope of the invention recited in claims and the equivalents thereof.

The entire disclosure of Japanese Patent Application No. 2012-202368 filed on Sep. 14, 2012 including description, claims, drawings, and abstract are incorporated herein by reference in its entirety.

What is claimed is:

1. A kanji stroke order learning device, comprising:
a kanji part stroke order storage unit which stores a plurality of stroke order data of kanji parts, each kanji part including at least one radical;
a kanji part combination storage unit which stores kanji and kanji parts included in the kanji in association to each other;
a kanji specifying unit which specifies any kanji as a specified kanji based on an operation performed by a user;
a stroke order input unit which inputs stroke order of the specified kanji based on an operation performed by a user;
a kanji part stroke order determination unit which determines whether the stroke order of the specified kanji input by the stroke order input unit is correct or incorrect for each kanji part included in the specified kanji by reading out kanji parts included in the specified kanji from the kanji part combination storage unit and by reading out stroke order of each of the read kanji parts from the kanji part stroke order storage unit; and
a kanji part stroke order correct/incorrect display control unit which displays a determination result obtained by the kanji part stroke order determination unit for each kanji part included in the specified kanji.

2. The kanji stroke order learning device according to claim 1, further comprising:
a kanji part input order storage unit which stores input order of the kanji parts included in a kanji for each kanji;
a kanji part input order determination unit which reads out the input order of the kanji parts included in the specified kanji from the kanji part input order storage unit and determines whether input order of the kanji parts of the specified kanji input by the stroke order input unit is correct or incorrect; and
a kanji part input order correct/incorrect display control unit which displays a determination result obtained by the kanji part input order determination unit.

3. The kanji stroke order learning device according to claim 2, further comprising:
a kanji stoke order determination unit which determines whether the stroke order of the specified kanji as a whole input by the stroke order input unit is correct or incorrect;
a correct kanji storage unit which accumulates and stores the specified kanji if the stroke order of the specified kanji as a whole is determined as being correct by the kanji stroke order determination unit; and
a kanji display control unit which, if stroke order of any kanji part included in the specified kanji is determined as being incorrect by the kanji part stroke order determination unit, reads out and displays a kanji which includes the kanji part and which is different from the specified kanji from the correct kanji storage unit.

4. The kanji stroke order learning device according to claim 1, further comprising:
a specified kanji storage unit which stores and accumulates the specified kanji;
a text display unit which displays a text based on an operation performed by a user; and
a kanji distinguishing display unit which displays a kanji including a kanji part same as a kanji part included in a kanji stored in the specified kanji storage unit among kanji in the text displayed by the text display unit.

5. A kanji stroke order learning support method of an electronic device comprising a kanji part stroke order storage unit which stores a plurality of stroke order data of kanji parts, each kanji part including at least one radical, and a kanji part combination storage unit which stores kanji and kanji parts included in the kanji in association to each other, the method comprising:
specifying any kanji as a specified kanji based on an operation performed by a user;
inputting stroke order of the specified kanji based on an operation performed by a user;
determining whether the stroke order of the specified kanji input in the inputting is correct or incorrect for each kanji part included in the specified kanji by reading out kanji parts included in the specified kanji from the kanji part combination storage unit and by reading out stroke order of each of the read kanji parts from the kanji part stroke order storage unit; and
displaying a determination result obtained in the determining for each kanji part included in the specified kanji.

6. A kanji stroke order learning system, comprising:
a terminal device and a server device which are connected to each other via a network;
a kanji part stroke order storage unit which stores a plurality of stroke order data of kanji parts, each kanji part including at least one radical;
a kanji part combination storage unit which stores kanji and kanji parts included in the kanji in association to each other;
a kanji specifying function for specifying any kanji as a specified kanji based on an operation performed by a user;
a stroke order input function for inputting stroke order of the specified kanji based on an operation performed by a user;
a kanji part stroke order determination function for determining whether the stroke order of the specified kanji input by the stroke order input function is correct or incorrect for each kanji part included in the specified kanji by reading out kanji parts included in the specified kanji from the kanji part combination storage unit and by reading out stroke order of each of the read kanji parts from the kanji part stroke order storage unit; and
a kanji part stroke order correct/incorrect display control function for displaying a determination result obtained by the kanji part stroke order determination function for each kanji part included in the specified kanji.

7. A non-transitory storage medium storing an input supporting program including a kanji stroke order learning program which makes a computer comprising a kanji part stroke order storage unit which stores a plurality of stroke order data of kanji parts, each kanji part including at least one radical, and a kanji part combination storage unit which stores kanji and kanji parts included in the kanji in association to each other realize following functions, the functions comprising:
a kanji specifying function for specifying any kanji as a specified kanji based on an operation performed by a user;
a stroke order input function for inputting stroke order of the specified kanji based on an operation performed by a user;
a kanji part stroke order determination function for determining whether the stroke order of the specified kanji input by the stroke order input function is correct or incorrect for each kanji part included in the specified kanji by reading out kanji parts included in the specified kanji from the kanji part combination storage unit and by reading out stroke order of each of the read kanji parts from the kanji part stroke order storage unit; and
a kanji part stroke order correct/incorrect display control function for displaying a determination result obtained by the kanji part stroke order determination function for each kanji part included in the specified kanji.
